(19) United States
(12) Patent Application Publication
(10) Pub. No.: US 2026/0238261 A1
(43) Pub. Date: Aug. 13, 2026

(54) SECURE TRANSMISSION IN RIS-ASSISTED ISAC SYSTEM

(71) Applicant: Lenovo (Beijing) Limited, Beijing (CN)

(72) Inventors: Tingnan Bao, Beijing (CN); Jianfeng Wang, Beijing (CN); Haiming Wang, Beijing (CN); Lihua Yang, Beijing (CN)

(73) Assignee: Lenovo (Beijing) Limited, Beijing (CN)

(21) Appl. No.: 19/474,662

(22) PCT Filed: Apr. 12, 2023
(86) PCT No.: PCT/CN2023/087835

§ 371 Date: Oct. 10, 2025

(51) Int. Cl. H04B 7/04; H04B 17/318

(52) U.S. Cl. CPC H04B 7/04013; H04B 17/328

(57) ABSTRACT

Methods and apparatuses for secure transmission in RIS-assisted ISAC system are disclosed. In one embodiment, a first base unit comprises a transceiver; and a processor coupled to the transceiver, wherein the processor is to cause the first base unit to: transmit, at least via a first RIS, to a first UE and first RIS, to a first UE and a second UE, a reference signal and a sensing signal; assign, to the first RIS, a first optimal phase shift coefficient determined according to response signal to the reference signal from the first UE; determine the location of a second UE according to an echo signal of the sensing signal from the second UE, and transmit, to a second base unit, the location of the second UE to instruct the second base unit to assign, to a second RIS, a second optimal phase shift coefficient determined according to the location of the second UE; determine an artificial noise according to a channel of the first UE, and transmit, to second base unit, the artificial noise; and transmit, at least via the first RIS with the first optimal phase shift coefficient, to the first UE, a data signal at the same time when the second base unit, second base unit transmits, via the second RIS with the second optimal phase shift coefficient. to the second UE, the artificial noise.

### FIELD

The subject matter disclosed herein generally relates to wireless communications, and more particularly relates to methods and apparatuses for secure transmission in re-configurable intelligent surface (RIS)-assisted integrated sensing and communication (ISAC) system.

### BACKGROUND

ISAC technology allows for simultaneous use of the same hardware and frequency band for both sensing and communication functions. However, the performance of the ISAC system is negatively impacted by adverse propagation conditions, which can result in signal blockages and particularly affect the system's ability to sense targets.

Reconfigurable Intelligent Surface (RIS) is a large and thin metasurface of metallic or dielectric material, comprised of an array of passive sub-wavelength scattering elements with specially designed physical structure. The elements can be controlled in a software-defined manner to change the electromagnetic (EM) properties (e.g., phase shift and/or amplitude attenuation) of the reflection of the incident radio frequency (RF) signals. By a joint phase control of all scattering elements, the reflected radiation pattern of the incident RF signals can be arbitrarily tuned in real time.

As a whole, it is attractive to use the RIS in the ISAC system to establish virtual line of sight (LoS) connections for both communication and sensing purposes.

In the ISAC system, the transmitted signals not only contain sensing signals, but also communication signals. Although high-level encryption can protect the communication signals containing the data, the ISAC system is still vulnerable to malicious targets, which can affect the communication privacy.

This invention targets secure transmission in RIS-assisted ISAC system.

### BRIEF SUMMARY

Methods and apparatuses for secure transmission in RIS-assisted ISAC system are disclosed.

In one embodiment, a first base unit comprises a transceiver; and a processor coupled to the transceiver, wherein the processor is to cause the first base unit to: transmit, at least via a first RIS, to a first UE and a second UE, a reference signal and a sensing signal; assign, to the first RIS, a first optimal phase shift coefficient determined according to response signal to the reference signal from the first UE; determine the location of a second UE according to an echo signal of the sensing signal from the second UE, and transmit, to a second base unit, the location of the second UE to instruct the second base unit to assign, to a second RIS, a second optimal phase shift coefficient determined according to the location of the second UE; determine an artificial noise according to a channel of the first UE, and transmit, to second base unit, the artificial noise; and transmit, at least via the first RIS with the first optimal phase shift coefficient, to the first UE, a data signal at the same time when the second base unit transmits, via the second RIS with the second optimal phase shift coefficient, to the second UE, the artificial noise.

In some embodiment, the response signal includes measurement of SINRs or SNRs or RSRPs each of which is measured under a phase shift coefficient of the first RIS.

In some embodiment, the artificial noise is transmitted to the second base unit over Xn signaling.

In some embodiment, the processor is further to cause the first base unit to: send a radio resource management coordination to a core network node to coordinate that the first base unit transmits the data signal at the same time when the second base unit transmits the artificial noise.

In another embodiment, a first UE comprises a transceiver; and a processor coupled to the transceiver, wherein the processor is to cause the first UE to: receive, at least via a first RIS, from a first base unit, a reference signal via, and assign, to the first RIS, a first optimal phase shift coefficient determined according to measurement of the reference signal; receive, via the first RIS, from the a second UE, an echo signal of a sensing signal sent from the first base unit to the second UE, and transmit, to a third UE, a location of the second UE determined according to the echo signal to instruct the third UE to assign, to a second RIS, a second optimal phase shift coefficient determined according to the location of the second UE; determine an artificial noise according to a channel of the first UE, and transmit, to a second base unit, the artificial noise; and receive, at least via the first RIS with the first optimal phase shift coefficient, from the first base unit, a data signal at the same time when the second base unit transmits, via the second RIS with the second optimal phase shift coefficient, to the second UE, the artificial noise.

In some embodiment, the artificial noise is transmitted via PC5 interface to the third UE which transmits the artificial noise to the second base unit.

In some embodiment, the processor is further to cause the first UE to: send a radio resource management coordination to a core network node to coordinate that the first base unit transmits the data signal at the same time when the second base unit transmits the artificial noise.

In yet another embodiment, a network node comprises a transceiver; and a processor coupled to the transceiver, wherein the processor is to cause the network node to: receive, via a first RIS, from a first UE, a response signal to a reference signal sent at least via the first RIS from a first base unit to the first UE, and assign, to the first RIS, a first optimal phase shift coefficient determined according to the response signal; receive, via the first RIS, from a second UE, an echo signal of a sensing signal sent from a first base unit to second UE, and assign, to a second RIS, a second optimal phase shift coefficient determined according to the location of the second UE determined according to the echo signal; and transmit, to a second base unit, an artificial noise determined according to a channel of the first UE.

In some embodiment, a first predetermined interface is configured between the network node and each of the first RIS and the second RIS.

In some embodiment, a second predetermined interface is configured between the network node and the second base unit.

In some embodiment, the processor is further to cause the network node to: send a radio resource management coordination to a core network node to coordinate that the first base unit transmits, at least via the first RIS with the first optimal phase shift coefficient, to the first UE, a data signal at the same time when the second base unit transmits, via the second RIS with the second optimal phase shift coefficient, to the second UE, the artificial noise.

In one embodiment, a method performed at a first base unit comprises: transmitting, at least via a first RIS, to a first UE and a second UE, a reference signal and a sensing signal; assigning, to the first RIS, a first optimal phase shift coefficient determined according to response signal to the reference signal from the first UE; determining the location of a second UE according to an echo signal of the sensing signal from the second UE, and transmitting, to a second base unit, the location of the second UE to instruct the second base unit to assign, to a second RIS, a second optimal phase shift coefficient determined according to the location of the second UE; determining an artificial noise according to a channel of the first UE, and transmitting, to second base unit, the artificial noise; and transmitting, at least via the first RIS with the first optimal phase shift coefficient, to the first UE, a data signal at the same time when the second base unit transmits, via the second RIS with the second optimal phase shift coefficient, to the second UE, the artificial noise.

In another embodiment, a method performed at a first UE comprises: receiving, at least via a first RIS, from a first base unit, a reference signal via, and assigning, to the first RIS, a first optimal phase shift coefficient determined according to measurement of the reference signal; receiving, via the first RIS, from the a second UE, an echo signal of a sensing signal sent from the first base unit to the second UE, and transmitting, to a third UE, a location of the second UE determined according to the echo signal to instruct the third UE to assign, to a second RIS, a second optimal phase shift coefficient determined according to the location of the second UE; determining an artificial noise according to a channel of the first UE, and transmitting, to a second base unit, the artificial noise; and receiving, at least via the first RIS with the first optimal phase shift coefficient, from the first base unit, a data signal at the same time when the second base unit transmits, via the second RIS with the second optimal phase shift coefficient, to the second UE, the artificial noise.

In yet another embodiment, a method performed at a network node comprises receiving, via a first RIS, from a first UE, a response signal to a reference signal sent at least via the first RIS from a first base unit to the first UE, and assigning, to the first RIS, a first optimal phase shift coefficient determined according to the response signal; receiving, via the first RIS, from a second UE, an echo signal of a sensing signal sent from a first base unit to second UE, and assigning, to a second RIS, a second optimal phase shift coefficient determined according to the location of the second UE determined according to the echo signal; and transmitting, to a second base unit, an artificial noise determined according to a channel of the first UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a RIS-assisted ISAC system;

FIG. 2 illustrates a procedure according to a first embodiment;

FIG. 3 illustrates a procedure according to a second embodiment;

FIG. 4 illustrates a procedure according to a third embodiment;

FIG. 5 is a schematic flow chart diagram illustrating an embodiment of a method;

FIG. 6 is a schematic flow chart diagram illustrating an embodiment of a method;

FIG. 7 is a schematic flow chart diagram illustrating an embodiment of a method; and

FIG. 8 is a schematic block diagram illustrating apparatuses according to one embodiment.

### DETAILED DESCRIPTION

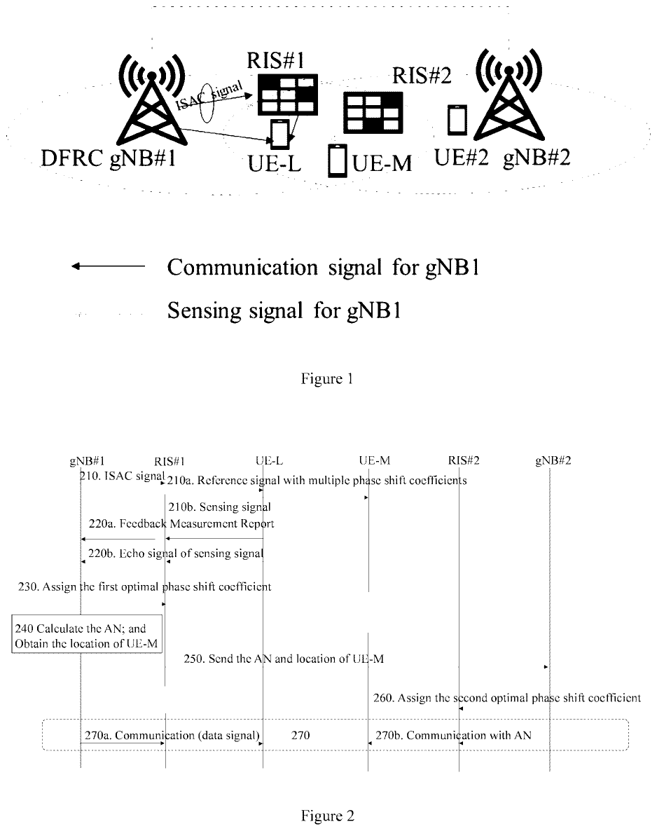

FIG. 1 illustrates a RIS-assisted ISAC system. It is assumed that each RIS (e.g., RIS #1 and RIS #2) is a passive RIS. As shown in FIG. 1, a cell-edge legitimate user, e.g., UE-L, is located between a source cell and a neighboring cell (which means that it is located within both the source cell and the neighboring cell). A source base unit (e.g., a source Next Generation Node B (gNB) such as gNB #1) and RIS #1 are within the source cell. A neighboring base unit (e.g., a neighboring gNB such as gNB #2) and RIS #2 are within the neighboring cell. A malicious eavesdropper (e.g., UE-M) is located nearby UE-L, which means that UE-M is also located between the source cell and the neighboring cell (i.e., located within both the source cell and the neighboring cell). The malicious eavesdropper UE-M tries to intercept confidential communication (e.g., confidential communication between gNB #1 and UE-L).

It is assumed that gNB #1 supports dual-function radar-communication (DFRC). It means that gNB #1 can exploit ISAC technology, i.e., can simultaneously provide communication service for users and acquire information of sensing targets.

In addition, RIS (e.g., RIS #1) can forward the ISAC signal (e.g., including communication signal (e.g., to UE-L) and sensing signal (e.g., to UE-M)) from gNB (e.g., DFRC gNB #1) to a target area, and receive response signal to the communication signal (e.g., from UE-M) and echo signal to the sensing signal (e.g., from UE-L) and forward the response signal and the echo signal to DFRC gNB #1. It means that a cascaded link is established between gNB #1 and UE-L (or UE-M) via RIS #1. On the other hand, the communication signal is also sent without the involvement of the RIS (which means a direct link (e.g., between gNB #1 and UE-L).

From UE-L's perspective on the communication signal, the received signal (e.g., communication signal) can be obtained from both the direct link from gNB #1 and the cascaded link via RIS #1 from gNB #1. From UE-M's perspective on the sensing signal, the received signal (e.g., sensing signal) can be obtained from the cascaded link via RIS #1 from gNB #1.

gNB #2 can be an ordinary gNB (which means that it only provides communication service for users) or a DFRC gNB (which means that it provides both communication service and sensing service). That is, gNB #2 can provide communication service. In particular, gNB #2 can provide communication service via RIS #2. In this disclosure, it is assumed that the direct link from gNB #2 to either UE-L or UE-M can be blocked. It means that the inter-cell interference from the neighboring cell to the source cell can be ignored. That is, gNB #2 only transmit signal via RIS #2 to UE-M (and/or UE-L).

A concept of secure communication is described. A secure rate (e.g., Cₛ) is defined as the difference between the capacity (e.g., Cₗ) of legitimate user (e.g., UE-L) and the capacity (e.g., Cₘ) of malicious eavesdropper (e.g., UE-M), that is, Cₛ=Cₗ−Cₘ=log₂(1+γₗ)−log₂(1+γₘ), where, γₗis the received signal to interference plus noise ratio (SINR) or signal to noise ratio (SNR) or Reference Signal Receiving Power (RSRP) at UE-L, γₘ is the SINR or SNR or RSRP at UE-M. If Cₛ>0, the secure communication can be guaranteed. Otherwise (i.e., if Cₛ≤0), the confidential message to UE-L can be eavesdropped by UE-M.

It can be seen that, in order to increasing the secure rate Cₛ, it is possible to increase γₗ(i.e., the SINR or SNR or RSRP at UE-L) and/or decrease γₘ (i.e., the SINR or SNR or RSRP at UE-M). In addition, the premise to decrease γₘ (i.e., the SINR or SNR or RSRP at UE-M) is to know that UE-M exists.

The SINR or SNR or RSRP at UE-L (γₗ) depends on the received communication signal, which comes from both the direct link from gNB #1 and the cascaded link via RIS #1 from gNB #1 if it is assumed that the signal from gNB #2 is blocked. The communication signal from the cascaded link can be adjusted by adjusting the phase shift coefficient of RIS #1, so that the signal reflected by RIS #1 can point to UE-L, thus increasing γₗ. On the other hand, the communication signal from the direct link only depends on the channel of the direct link, and cannot be adjusted. So, this disclosure only focuses the effect on the cascaded link, e.g., to increase γₗ.

The SINR or SNR or RSRP at UE-M (γₘ) also depends the cascaded link and the direct link. Similar, due to the channel of the direct link not being adjustable, this disclosure only focuses the cascaded link to decrease γₘ.

As mentioned above, the cascaded link via RIS #1 from gNB #1 is adjusted (i.e., an optimal phase shift coefficient of RIS #1 is chosen) to increase γₗ. This disclosure proposes to adjust another cascaded link via RIS #2 from gNB #2 to decrease γₘ while not affecting γₗ. For example, a noise signal can be sent via RIS #2 from gNB #2 to decrease γₘ.

This disclosure proposes to determine the noise signal which can not affect γₗ, since the noise signal via RIS #2 from gNB #2 will also be received at UE-L. For example, an artificial noise (AN) can be determined according to the channel for UE-L. The channel for UE-L may refer to the channel of both the cascaded link (via RIS #1 from gNB #1) and the direct link (directly from gNB #1) for UE-L, or the channel of the cascaded link (via RIS #1 from gNB #1) for UE-L (e.g., in the condition that the direct link from gNB #1 to UE-L is blocked). It is assumed that the channel for UE-L is G_{L}, the artificial noise (AN) can be determined by letting AN⊗G_{L}=0. It means that the AN is orthogonal to the channel for UE-L, that is, the AN determined by letting AN⊗G_{L}=0 does not affect γₗ (i.e., the SINR or SNR or RSRP at UE-L). As a whole, the AN can be transmitted to UE-M as the interference (which can decrease γₗ) and does not affect the channel for UE-L (i.e., not affecting or not decreasing γₗ). Since the phase shift coefficient of RIS #1 is adjusted so that the signal reflected by RIS #1 points to UE-L, it is not favorite to send AN from gNB #1 via RIS #1 to UE-M. In view of the above, this disclosure proposes that AN can be sent from another gNB (e.g., gNB #2) via another RIS (e.g., RIS #2), while the phase shift coefficient of RIS #2 can be adjusted so that the signal (e.g., AN) reflected by RIS #2 points to UE-M.

Based on the above analysis, three embodiments are proposed for implementation.

A first embodiment for secure transmission in RIS-assisted ISAC system is described with reference to FIG. 2.

In the first embodiment, it is assumed that each RIS in a cell is controlled by gNB in the cell. For example, RIS #1 is controlled by gNB #1; and RIS #2 is controlled by gNB #2.

In step 210, gNB #1 sends, to RIS #1, ISAC signal including communication signal, which is a reference signal, to UE-L and sensing signal to UE-M. In step 210a, RIS #1 forwards the reference signal by using multiple discrete phase shift coefficients to UE-L; and in step 210b, RIS #1 forwards the sensing signal to find UE-M. As a whole, the communication signal (i.e., the reference signal) is sent to UE-L by cascaded link (i.e., via RIS #1 from gNB #1); and the sensing signal is sent to UE-M by cascaded link (i.e., via RIS #1 from gNB #1). Incidentally, the communication signal (i.e., the reference signal) may be also sent from gNB #1 directly to UE-L (if the direct link between gNB #1 and UE-L is not blocked).

In step 220a, UE-L feeds back a measurement report (e.g., CSI report) including SINRs or SNRs (e.g., L1-SINRs) or RSRPs (e.g., L1-RSRPs), where each SINR or SNR or RSRP is obtained based on one of multiple discrete phase shift coefficients in RIS #1, to gNB #1 via RIS #1 (i.e., by the cascaded link). The measurement report is obtained by measuring the reference signal sent by the cascaded link (i.e., via RIS #1) and optionally the direct link. Incidentally, if the reference signal is also received by the direct link in addition to the cascaded link, the measurement report is sent by both the cascaded link and the direct link.

In step 220b, if UE-M exists, the echo signal of the sensing signal is fed back to gNB #1 via RIS #1 (i.e., by the cascaded link).

In step 230, gNB #1 determines an optimal phase shift coefficient for RIS #1 according to the received CSI report (e.g., according to the maximum value of the L1-RSRPs or L1-SINRs, each of which is based on one of the multiple discrete phase shift coefficients in RIS #1, contained in the CSI report), and assigns the optimal phase shift coefficient to RIS #1.

In step 240, gNB #1 calculates an AN based on the channel G_{L} of UE-L (e.g., the channel of both the cascaded link and the direct link, or the channel of the cascaded link (e.g., in the condition that the direct link is blocked)). For example, the AN can be calculated from AN⊗G_{L}=0. The AN means a noise that can decrease γₘ (i.e., the SINR or SNR or RSRP at UE-M) while not affecting γₗ (i.e., the SINR or SNR or RSRP at UE-L) (i.e., γₗ is not affected or decreased by the AN). In other words, the AN is only a noise to UE-M but not a noise to UE-L. In step 240, gNB #1 also determines the location of UE-M according to the echo signal of the sensing signal.

In step 250, gNB #1 sends the AN and the location of UE-M to gNB #2, e.g., via Xn interface between gNB #1 and gNB #2.

In step 260, gNB #2 determines a phase shift coefficient of RIS #2 according to the location of UE-M. It means that an optimal phase shift coefficient of RIS #2 is determined so that the signal reflected by RIS #2 can point to UE-M. gNB #2 assigns the optimal phase shift coefficient of RIS #2 to RIS #2. Accordingly, gNB #2 is able to send the AN to UE-M via RIS #2 to decrease γₘ (i.e., the SINR or SNR at UE-M).

In step 270, gNB #1 sends communication signal (e.g., data signal) to UE-L (e.g., in step 270a) while gNB #2 sends the AN (as a signal) to UE-M via RIS #2 (e.g., in step 270b).

Although FIG. 2 only shows that the data signal is sent from gNB #1 via RIS #1 to UE-L, it is possible that the data signal can also be sent directly from gNB #1 to UE-L (if the direct link between gNB #1 and UE-L is not blocked).

To ensure that when gNB #1 sends the data signal to UE-L, gNB #2 is sending the AN to UE-M via RIS #2, a radio resource management coordination can be requested from Radio Access Network (RAN) (e.g., gNB #1) to the core network (e.g., a core network node) to request gNB #2 sends the AN to UE-M via RIS #2 when gNB #1 sends the data signal to UE-L.

Since the AN decreases γₘ (i.e., the SINR or SNR at UE-M) while not decreasing γₗ(i.e., the SINR or SNR at UE-L), the secure rate Cₛ=Cₗ−Cₘ=log₂(1+γₗ)−log₂(1+γₘ) is increased. Accordingly, the secure communication can be improved when gNB #1 sends the data signal to UE-L at the same time when gNB #2 is sending the AN to UE-M via RIS #2.

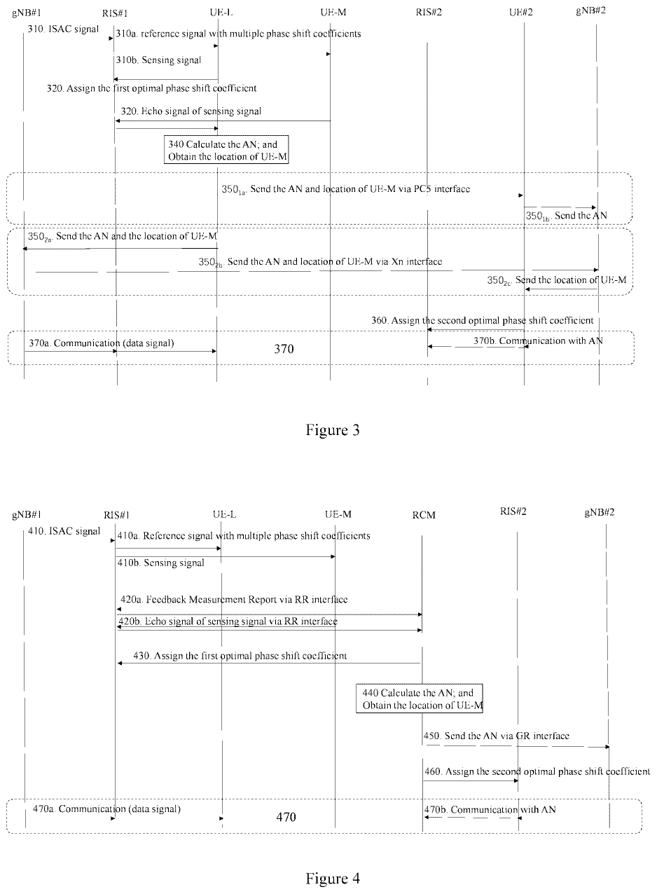

A second embodiment for secure transmission in RIS-assisted ISAC system is described with reference to FIG. 3.

In the second embodiment, it is assumed that each RIS in a cell is controlled by a UE in the cell. For example, RIS #1 is controlled by UE #1 (e.g., UE-L); and RIS #2 is controlled by UE #2, which is a UE different from UE-L or UE-M.

In step 310, gNB #1 sends, to RIS #1, ISAC signal including communication signal, which is a reference signal, to UE-L and sensing signal to UE-M. In step 310a, RIS #1 forwards the reference signal by using multiple discrete phase shift coefficients to UE-L; and in step 310b, RIS #1 forwards the sensing signal to find UE-M. Similar to the first embodiment, the communication signal (i.e., the reference signal) may be also sent from gNB #1 directly to UE-L (if the direct link between gNB #1 and UE-L is not blocked).

In step 320, UE-L determines an optimal phase shift coefficient for RIS #1 according to the maximum value of the received L1-RSRPs or L1-SINRs, where each L1-RSRP or L1-SINR is obtained based on one of the multiple discrete phase shift coefficients in RIS #1, and assigns the optimal phase shift coefficient (e.g., corresponding to the L1-RSRP or L1-SINR having the maximum value) to RIS #1 for improving the system performance (i.e., increasing/1).

In step 330, if UE-M exists, the echo signal of the sensing signal can be fed back via RIS #1 to UE-L (since UE-L controls RIS #1).

In step 340, UE-L calculates an artificial noise (AN) based on the channel of UE-L (e.g., the channel of both the cascaded link and the direct link, or the channel of the cascaded link (e.g., in the condition that the direct link is blocked)). The calculation of AN is the same as that described in step 240. In step 340, UE-L also determines the location of UE-M according to the echo signal of the sensing signal.

In step 350, the AN is necessary to be sent to gNB #2 (so that gNB #2 can send the AN, e.g., via RIS #2), and the location of UE-M is necessary to be sent to UE #2 (so that UE #2 can assign an optimal phase shift coefficient of RIS #2 to RIS #2 which means that the signal reflected by RIS #2 can point to UE-M).

Step 350 can be implemented as step 350₁ₐ and 350_{1b} if sidelink protocol is enabled between UE-L and UE #2 (which means there is PC5 interface between UE-L and UE #2). In step 350₁ₐ, UE-L sends the AN and the location of UE-M to UE #2 via PC5 interface. In step 350_{1b}, UE #2 sends the AN to gNB #2, e.g., via a CSI report.

Step 350 can alternatively be implemented as step 350₂ₐ, 350_{2b} and 350_{2c} if sidelink protocol is not enabled between UE-L and UE #2 (or PC5 interface is not used). In step 350₂ₐ, UE-L sends the AN and the location of UE-M to gNB #1, e.g., by a CSI report. In step 350_{2b}, gNB #1 sends the AN and the location of UE-M to gNB #2, e.g., via Xn interface. In step 350_{2c}, gNB #2 sends the location of UE-M to UE #2, e.g., via RRC signaling or MAC CE, or DCI.

Accordingly, in step 360, UE #2 determines a phase shift coefficient of RIS #2 according to the location of UE-M. It means that an optimal phase shift coefficient of RIS #2 is determined so that the signal reflected by RIS #2 can point to UE-M. UE #2 assigns the optimal phase shift coefficient of RIS #2 to RIS #2.

In step 370, gNB #1 sends communication signal (e.g., data signal) to UE-L (e.g., in step 370a) at the same time when gNB #2 is sending the AN (as a signal) to UE-M via RIS #2 (e.g., in step 370b). Step 370a is the same as step 270a; and step 370b is the same as step 270b.

To ensure that when gNB #1 sends the data signal to UE-L, gNB #2 is sending the AN to UE-M via RIS #2, a radio resource management coordination can be requested from UE #1 via gNB #1 or from UE #2 via gNB #2 to the core network (e.g., a core network node) to make coordination.

A third embodiment for secure transmission in RIS-assisted ISAC system is described with reference to FIG. 4.

In the third embodiment, it is assumed that each RIS is controlled by a RIS controller that is equipped in a new network node (e.g., RIS controller management function (RCM)). It is proposed that a first new interface (e.g., GR interface) is defined between gNB and RCM to support signaling exchange between gNB and RCM, and that a second new interface (e.g., RR interface) is defined between RIS and RCM to support signaling exchange between RSI and RCM. For example, both RIS #1 and RIS #2 are controlled by RCM (e.g., by RIS controller in RCM).

In step 410, gNB #1 sends, to RIS #1, ISAC signal including communication signal, which is a reference signal, to UE-L and sensing signal to UE-M. In step 410a, RIS #1 forwards the reference signal by using multiple discrete phase shift coefficients to UE-L; and in step 410b, RIS #1 forwards the sensing signal to find UE-M. Similar to the first embodiment, the communication signal (i.e., the reference signal) may be also sent from gNB #1 directly to UE-L (if the direct link between gNB #1 and UE-L is not blocked).

In step 420a, UE-L feeds back a measurement report including L1-SINRs or L1-RSRPs, each of which is based on one of the multiple discrete phase shift coefficients in RIS #1, e.g., by CSI report, via RIS #1 to RCM by using RR interface.

In step 420b, if UE-M exists, the echo signal of the sensing signal is fed back via RIS #1 to RCM by using RR interface.

In step 430, RCM determines an optimal phase shift coefficient for RIS #1 according to the received CSI report (e.g., according to the maximum value of the L1-RSRPs or L1-SINRs, each of which is based on one of the multiple discrete phase shift coefficients in RIS #1, contained in the CSI report), and assigns the optimal phase shift coefficient to RIS #1.

In step 440, RCM calculates an artificial noise (AN) based on the channel of UE-L by the same manner as described in step 240. In addition, RCM determines the location of UE-M according to the echo signal of the sensing signal.

In step 450, RCM sends the AN to gNB #2 via GR interface.

In step 460, RCM determines a phase shift coefficient of RIS #2 according to the location of UE-M. It means that an optimal phase shift coefficient of RIS #2 is determined so that the signal reflected by RIS #2 can point to UE-M. RCM assigns the optimal phase shift coefficient of RIS #2 to RIS #2 via RR interface.

In step 470, gNB #1 sends communication signal (e.g., data signal) to UE-L (e.g., in step 470a) at the same time when gNB #2 is sending the AN (as a signal) to UE-M via RIS #2 (e.g., in step 470b). Step 470a is the same as step 270a; and step 470b is the same as step 270b.

To ensure that when gNB #1 sends the data signal to UE-L, gNB #2 is sending the AN to UE-M via RIS #2, a radio resource management coordination can be requested from RCM to the core network to make coordination.

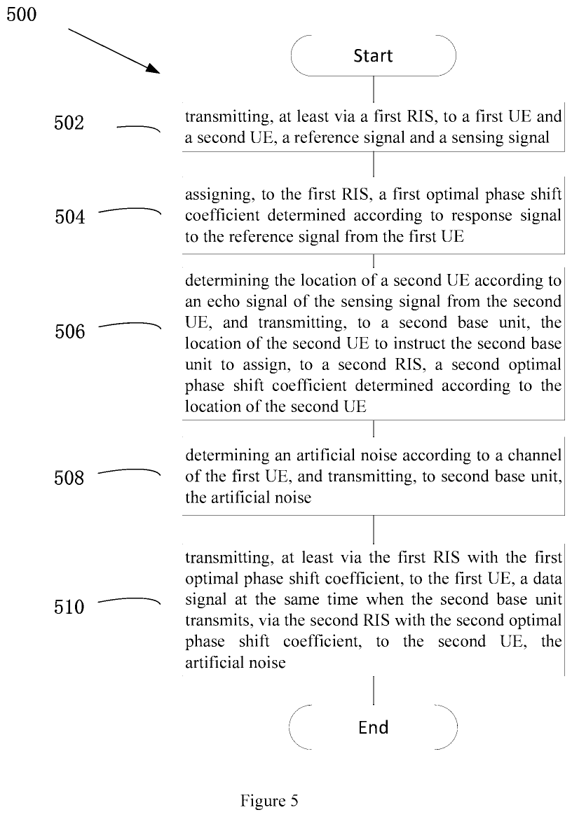

FIG. 5 is a schematic flow chart diagram illustrating an embodiment of a method 500 according to the present application. In some embodiments, the method 500 is performed by an apparatus, such as a base station (e.g., a first base unit). In certain embodiments, the method 500 may be performed by a processor executing program code, for example, a microcontroller, a microprocessor, a CPU, a GPU, an auxiliary processing unit, a FPGA, or the like.

The method 500 may include 502 transmitting, at least via a first RIS, to a first UE and a second UE, a reference signal and a sensing signal; 504 assigning, to the first RIS, a first optimal phase shift coefficient determined according to response signal to the reference signal from the first UE; 506 determining the location of a second UE according to an echo signal of the sensing signal from the second UE, and transmitting, to a second base unit, the location of the second UE to instruct the second base unit to assign, to a second RIS, a second optimal phase shift coefficient determined according to the location of the second UE; 508 determining an artificial noise according to a channel of the first UE, and transmitting, to second base unit, the artificial noise; and 510 transmitting, at least via the first RIS with the first optimal phase shift coefficient, to the first UE, a data signal at the same time when the second base unit transmits, via the second RIS with the second optimal phase shift coefficient, to the second UE, the artificial noise.

In some embodiment, the response signal includes measurement of SINRs or SNRs or RSRPs each of which is measured under a phase shift coefficient of the first RIS.

In some embodiment, the artificial noise is transmitted to the second base unit over Xn signaling.

In some embodiment, the method further comprises sending a radio resource management coordination to a core network node to coordinate that the first base unit transmits the data signal at the same time when the second base unit transmits the artificial noise.

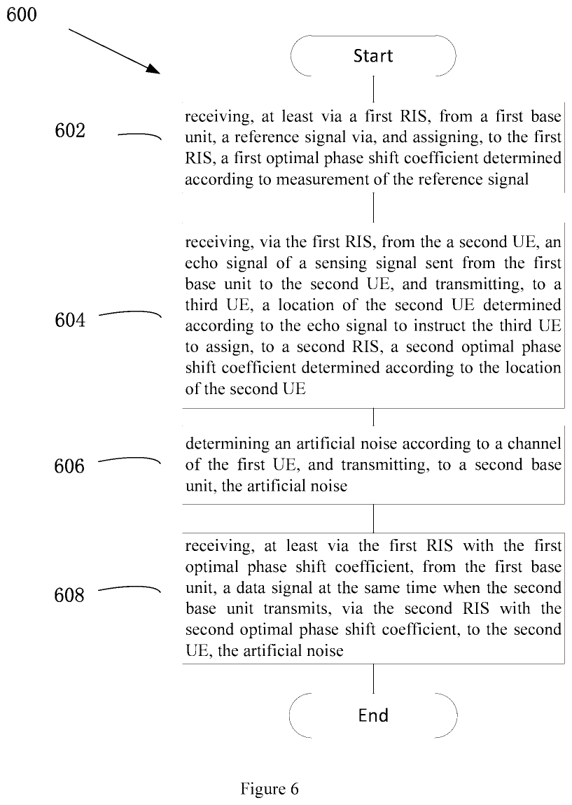

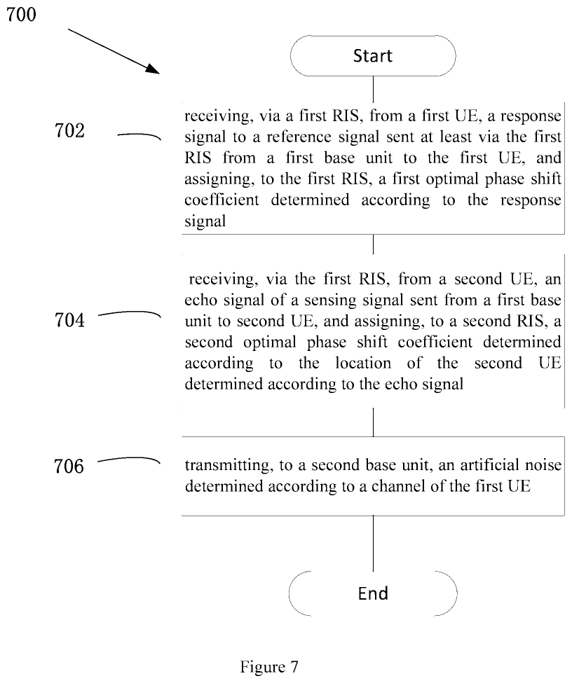

FIG. 6 is a schematic flow chart diagram illustrating an embodiment of a method 600 according to the present application. In some embodiments, the method 600 is performed by an apparatus, such as a remote unit (e.g., a first UE). In certain embodiments, the method 600 may be performed by a processor executing program code, for example, a microcontroller, a microprocessor, a CPU, a GPU, an auxiliary processing unit, a FPGA, or the like.

The method 600 may include 602 receiving, at least via a first RIS, from a first base unit, a reference signal via, and assigning, to the first RIS, a first optimal phase shift coefficient determined according to measurement of the reference signal; 604 receiving, via the first RIS, from the a second UE, an echo signal of a sensing signal sent from the first base unit to the second UE, and transmitting, to a third UE, a location of the second UE determined according to the echo signal to instruct the third UE to assign, to a second RIS, a second optimal phase shift coefficient determined according to the location of the second UE; 606 determining an artificial noise according to a channel of the first UE, and transmitting, to a second base unit, the artificial noise; and 608 receiving, at least via the first RIS with the first optimal phase shift coefficient, from the first base unit, a data signal at the same time when the second base unit transmits, via the second RIS with the second optimal phase shift coefficient, to the second UE, the artificial noise.

In some embodiment, the artificial noise is transmitted via PC5 interface to the third UE which transmits the artificial noise to the second base unit.

In some embodiment, the method further comprises sending a radio resource management coordination to a core network node to coordinate that the first base unit transmits the data signal at the same time when the second base unit transmits the artificial noise.

FIG. 7 is a schematic flow chart diagram illustrating an embodiment of a method 700 according to the present application. In some embodiments, the method 700 is performed by a network node, such as RCM. In certain embodiments, the method 700 may be performed by a processor executing program code, for example, a microcontroller, a microprocessor, a CPU, a GPU, an auxiliary processing unit, a FPGA, or the like.

The method 700 may include 702 receiving, via a first RIS, from a first UE, a response signal to a reference signal sent at least via the first RIS from a first base unit to the first UE, and assigning, to the first RIS, a first optimal phase shift coefficient determined according to the response signal; 704 receiving, via the first RIS, from a second UE, an echo signal of a sensing signal sent from a first base unit to second UE, and assigning, to a second RIS, a second optimal phase shift coefficient determined according to the location of the second UE determined according to the echo signal; and 706 transmitting, to a second base unit, an artificial noise determined according to a channel of the first UE.

In some embodiment, a first predetermined interface is configured between the network node and each of the first RIS and the second RIS.

In some embodiment, a second predetermined interface is configured between the network node and the second base unit.

In some embodiment, the method further comprises sending a radio resource management coordination to a core network node to coordinate that the first base unit transmits, at least via the first RIS with the first optimal phase shift coefficient, to the first UE, a data signal at the same time when the second base unit transmits, via the second RIS with the second optimal phase shift coefficient, to the second UE, the artificial noise.

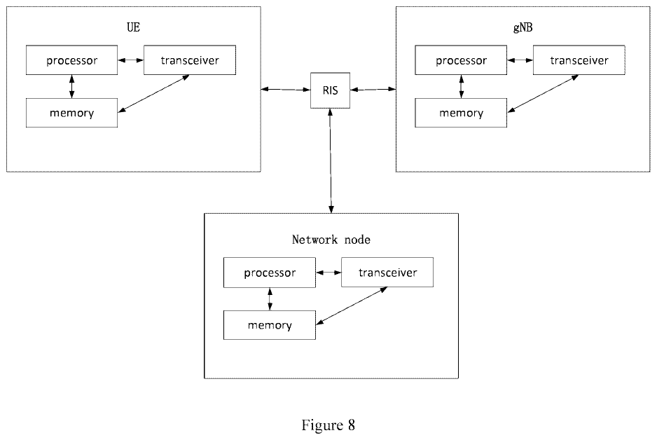

FIG. 8 is a schematic block diagram illustrating apparatuses according to one embodiment.

Referring to FIG. 8, the first base unit (e.g., gNB) includes a processor, a memory, and a transceiver that is a transmitter and/or a receiver. The processors implement a function, a process, and/or a method which are proposed in FIG. 5.

The first base unit comprises a transceiver; and a processor coupled to the transceiver, wherein the processor is to cause the first base unit to: transmit, at least via a first RIS, to a first UE and a second UE, a reference signal and a sensing signal; assign, to the first RIS, a first optimal phase shift coefficient determined according to response signal to the reference signal from the first UE; determine the location of a second UE according to an echo signal of the sensing signal from the second UE, and transmit, to a second base unit, the location of the second UE to instruct the second base unit to assign, to a second RIS, a second optimal phase shift coefficient determined according to the location of the second UE; determine an artificial noise according to a channel of the first UE, and transmit, to second base unit, the artificial noise; and transmit, at least via the first RIS with the first optimal phase shift coefficient, to the first UE, a data signal at the same time when the second base unit transmits, via the second RIS with the second optimal phase shift coefficient, to the second UE, the artificial noise.

In some embodiment, the response signal includes measurement of SINRs or SNRs or RSRPs each of which is measured under a phase shift coefficient of the first RIS.

In some embodiment, the artificial noise is transmitted to the second base unit over Xn signaling.

In some embodiment, the processor is further to cause the first base unit to: send a radio resource management coordination to a core network node to coordinate that the first base unit transmits the data signal at the same time when the second base unit transmits the artificial noise.

Referring to FIG. 8, the first UE (e.g., UE) includes a processor, a memory, and a transceiver that is a transmitter and/or a receiver. The processors implement a function, a process, and/or a method which are proposed in FIG. 6.

The first UE comprises a transceiver; and a processor coupled to the transceiver, wherein the processor is to cause the first UE to: receive, at least via a first RIS, from a first base unit, a reference signal via, and assign, to the first RIS, a first optimal phase shift coefficient determined according to measurement of the reference signal; receive, via the first RIS, from the a second UE, an echo signal of a sensing signal sent from the first base unit to the second UE, and transmit, to a third UE, a location of the second UE determined according to the echo signal to instruct the third UE to assign, to a second RIS, a second optimal phase shift coefficient determined according to the location of the second UE; determine an artificial noise according to a channel of the first UE, and transmit, to a second base unit, the artificial noise; and receive, at least via the first RIS with the first optimal phase shift coefficient, from the first base unit, a data signal at the same time when the second base unit transmits, via the second RIS with the second optimal phase shift coefficient, to the second UE, the artificial noise.

In some embodiment, the artificial noise is transmitted via PC5 interface to the third UE which transmits the artificial noise to the second base unit.

In some embodiment, the processor is further to cause the first UE to: send a radio resource management coordination to a core network node to coordinate that the first base unit transmits the data signal at the same time when the second base unit transmits the artificial noise.

Referring to FIG. 8, the network node (e.g., RCM) includes a processor, a memory, and a transceiver that is a transmitter and/or a receiver. The processors implement a function, a process, and/or a method which are proposed in FIG. 7.

The network node comprises a transceiver; and a processor coupled to the transceiver, wherein the processor is to cause the network node to: receive, via a first RIS, from a first UE, a response signal to a reference signal sent at least via the first RIS from a first base unit to the first UE, and assign, to the first RIS, a first optimal phase shift coefficient determined according to the response signal; receive, via the first RIS, from a second UE, an echo signal of a sensing signal sent from a first base unit to second UE, and assign, to a second RIS, a second optimal phase shift coefficient determined according to the location of the second UE determined according to the echo signal; and transmit, to a second base unit, an artificial noise determined according to a channel of the first UE.

In some embodiment, a first predetermined interface is configured between the network node and each of the first RIS and the second RIS.

In some embodiment, a second predetermined interface is configured between the network node and the second base unit.

In some embodiment, the processor is further to cause the network node to: send a radio resource management coordination to a core network node to coordinate that the first base unit transmits, at least via the first RIS with the first optimal phase shift coefficient, to the first UE, a data signal at the same time when the second base unit transmits, via the second RIS with the second optimal phase shift coefficient, to the second UE, the artificial noise.

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A first base unit for wireless communication, comprising:
at least one memory; and
at least one processor coupled with the at least one processor and configured to cause the first base unit to:
transmit a reference signal and a sensing signal;
assign, to a first reconfigurable intelligent surface (RIS), a first optimal phase shift coefficient determined according to a response signal to the reference signal from a first UE;
determine a location of a second UE according to an echo signal of the sensing signal;
transmit the location of the second UE to instruct a second base unit to assign, to a second RIS, a second optimal phase shift coefficient determined according to the location of the second UE;
determine an artificial noise according to a channel of the first UE;
transmit the artificial noise; and
transmit, with the first optimal phase shift coefficient, a data signal at a same time when the second base unit transmits the artificial noise.

2. The first base unit of claim 1, wherein the response signal includes measurement of signal to interference plus noise ratios (SINRs) or signal to noise ratios (SNRs) or reference signal receiving powers (RSRPs) each of which is measured under a phase shift coefficient of the first RIS.

3. The first base unit of claim 1, whereinto transmit the artificial noise, the at least one processor is configured to cause the first base unit to transmit the artificial noise over Xn signaling.

4. The first base unit of claim 1, wherein the at least one processor is further configured to cause the first base unit to send a radio resource management coordination to coordinate that the first base unit transmits the data signal at the same time when the second base unit transmits the artificial noise.

5. A first UE, comprising:
at least one memory; and
at least one processor coupled with the at least one processor and configured to cause the first UE to:
receive at a reference signal;
assign, to a first reconfigurable intelligent surface (RIS), a first optimal phase shift coefficient determined according to measurement of the reference signal;
receive an echo signal of a sensing signal sent;
transmit a location of a second UE determined according to the echo signal to instruct a third UE to assign, to a second RIS, a second optimal phase shift coefficient determined according to the location of the second UE;
determine an artificial noise according to a channel of the first UE;
transmit the artificial noise; and
receive a data signal at a same time when a first base unit transmits the artificial noise.

6. The first UE of claim 5, wherein to transmit the artificial noise, the at least one processor is configured to cause the first UE to transmit the artificial noise via a PC5 interface to the third UE.

7. The first UE of claim 5, wherein the at least one processor is further configured to cause the first UE to send a radio resource management coordination to coordinate that the first base unit transmits the data signal at a same time when a second base unit transmits the artificial noise.

8. A network node, comprising:
at least one memory; and
at least one processor coupled with the at least one processor and configured to cause the network node to:
receive a response signal to a reference signal;
assign, to a first reconfigurable intelligent surface (RIS), a first optimal phase shift coefficient determined according to the response signal;
receive an echo signal of a sensing signal;
assign, to a second RIS, a second optimal phase shift coefficient determined according to a location of a second UE determined according to the echo signal; and
transmit an artificial noise determined according to a channel of a first UE.

9. The network node of claim 8, wherein a predetermined interface is configured between the network node and each of the first RIS and the second RIS.

10. The network node of claim 8, wherein a second predetermined interface is configured between the network node and a base unit.

11. The network node of claim 8, wherein the at least one processor is further configured to cause the network node to send a radio resource management coordination to coordinate that a first base unit transmits, with the first optimal phase shift coefficient, a data signal at a same time when a second base unit transmits, with the second optimal phase shift coefficient the artificial noise.

12. A method performed by a first UE, the method comprising:
receiving a reference signal;
assigning, to a first reconfigurable intelligent surface (RIS), a first optimal phase shift coefficient determined according to measurement of the reference signal;
receiving an echo signal of a sensing signal sent;
transmitting a location of a second UE determined according to the echo signal to instruct a third UE to assign, to a second RIS, a second optimal phase shift coefficient determined according to the location of the second UE;
determining an artificial noise according to a channel of the first UE;
transmitting the artificial noise; and
receiving a data signal at a same time when a first base unit transmits the artificial noise.

13. The method of claim 12, wherein transmitting the artificial noise comprises transmitting the artificial noise via a PC5 interface to the third UE.

14. The method of claim 12, further comprising sending a radio resource management coordination to coordinate that the first base unit transmits the data signal at a same time when a second base unit transmits the artificial noise.
